(19) United States
(12) Patent Application Publication
(10) Pub. No.: US 2026/0301990 A1
(43) Pub. Date: Oct. 1, 2026

(54) SYSTEMS AND METHODS FOR CUSTOMIZING MICRO-COAXIAL CABLES

(71) Applicant: Meta Platforms Technologies, LLC, Menlo Park, CA (US)

(72) Inventors: Kristy Alana Jost, Woodinville, WA (US); Daniel Myers, Kirkland, WA (US); Brendon Allen Beardsley, Lake Stevens, WA (US); Li Yao, Kirkland, WA (US); Marcos Antonio Santana Andrade, JR., Seattle, WA (US); Omar Awartani, Redmond, WA (US); Inhwan Kim, Seattle, WA (US); Mehdi Mehrabi, Seattle, WA (US); Wenyang Pan, Redmond, WA (US); Sujal Tipnis, Redmond, WA (US); Thomas John Farrell Wallin, Redmond, WA (US)

(21) Appl. No.: 19/631,953

(22) Filed: Mar. 27, 2026

Related U.S. Application Data
(60) Provisional application No. 63/780,907, filed on Mar. 31, 2025.

(51) Int. Cl. H01B 7/00; H01B 9/04; H01B 13/016

(52) U.S. Cl. CPC H01B 7/009; H01B 9/04; H01B 13/016

(57) ABSTRACT

A method of the subject technology includes fabricating a customized micro-coaxial cable by using an extrusion process to connect a conductive core to a surface of a micro-coaxial cable and providing surface connections without using an ablation process.

### CROSS REFERENCE TO RELATED APPLICATION

This present application claims the benefit of priority under 35 U.S.C. § 119(e) to U.S. Provisional Application No. 63/780,907, filed Mar. 31, 2025, the disclosure of which is hereby incorporated by reference in its entirety for all purposes.

### TECHNICAL FIELD

The present disclosure generally relates to micro-coaxial cables, and more particularly, to systems and methods for customizing micro-coaxial cables.

### BACKGROUND

Micro-coaxial cables have many uses in electronics and can be integrated into various applications for transmitting data and signals. For example, micro-coaxial cables typically have smaller diameters than traditional coaxial cables and are useful for integration into more portable devices. However, traditional micro-coaxial cables have difficulty being scaled for even smaller footprints, such as for wearable devices and smart textiles. These traditional micro-coaxial cables may encounter problems such as unreliable connections when subjected to bending or stretching. Furthermore, for smart textiles, traditional cables may use materials such as silver-plated yarn that do not have shield or insulation materials, thus making them suboptimal for radio frequency (RF) and electronic applications due to a lack of electromagnetic interference protection and signal loss protection. Although typical micro-coaxial cables often have a core conductor and a shell that shields against electromagnetic interference (EMI), the shell prevents connections along the cables and may require connecting to both the core and the shield by cutting a cable to connect straight to the ends.

To provide access along the length of a cable, traditional micro-coaxial cables often rely on processes such as ablation to remove layers to expose a desired inner layer for soldering or crimping when connecting to other electronic components. For example, ablation can shave away or partially shave away outer layers to get to inner layers. Ablation processes can be time-consuming and may require special tools and expertise, thereby resulting in expensive and unreliable connections. Additionally, typical micro-coaxial cables may be continuous along the length of a cable, with identical cross-sections anywhere the cable is cut and without the possibility of customizing the cable.

### SUMMARY

According to some aspects, a method of the subject technology includes fabricating a customized micro-coaxial cable by using an extrusion process to connect a conductive core to a surface of a micro-coaxial cable and providing surface connections without using an ablation process.

According to other aspects, a device of the subject technology includes a customized micro-coaxial cable that comprise a conductive core connected to a surface of a micro-coaxial cable at customizable intervals, and customized segments of insulative and conductive materials at a plurality of layers of the micro-coaxial cable. The customized micro-coaxial cable is fabricated using an extrusion process.

According to yet other aspects, a wearable device of the subject technology includes electronic circuitry, and flexible electronic connectors including a customized micro-coaxial cable. The customized micro-coaxial cable includes a conductive core connected to a surface of a micro-coaxial cable at customizable intervals, and customized segments of insulative and conductive materials at a plurality of layers of the micro-coaxial cable. The customized micro-coaxial cable is fabricated using an extrusion process.

### BRIEF DESCRIPTION OF THE DRAWINGS

To easily identify the discussion of any particular element or act, the most significant digit or digits in a reference number refer to the figure number in which that element is first introduced.

FIG. 1 is a schematic diagram illustrating an example of a micro-coaxial cable, according to certain aspects of the disclosure.

FIG. 2 is a block diagram illustrating an example of method of manufacturing a micro-coaxial cable, according to certain aspects of the disclosure.

FIG. 3 is a schematic diagram illustrating top views of a comparison of exemplary micro-coaxial cable customized with ablation and without ablation, according to certain aspects of the disclosure.

FIG. 4 is a schematic diagram illustrating an example of a wrist-wearable device using some aspects of the subject technology.

FIG. 5 is a diagram illustrating example block diagrams of a computing system corresponding to the wrist-wearable device of FIG. 4.

FIG. 6 is a schematic diagram illustrating an example of an augmented reality (AR) system using some aspects of the subject technology.

FIGS. 7A and 7B are schematic diagrams illustrating an example of a virtual reality (VR) system using some aspects of the subject technology.

FIG. 8 is a diagram illustrating example block diagrams of a computing system corresponding to the AR device of FIG. 6 and the VR device of FIG. 7.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions may be provided in regard to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

It is to be understood that the present disclosure includes examples of the subject technology and does not limit the scope of the included clauses. Various aspects of the subject technology will now be disclosed according to particular but non-limiting examples. Various embodiments described in the present disclosure may be carried out in different ways and variations, and in accordance with a desired application or implementation.

In the following detailed description, numerous specific details are set forth to provide a full understanding of the present disclosure. It will be apparent, however, to one ordinarily skilled in the art, that embodiments of the present disclosure may be practiced without some of the specific details. In other instances, well-known structures and techniques have not been shown in detail so as not to obscure the disclosure.

Some aspects of the subject disclosure are directed to systems and methods for customizing micro-coaxial cables. As will be explained in greater detail below, embodiments of the present disclosure may, by using an extrusion process that connects a conductive core to the surface of a micro-coaxial cable at customizable intervals, provide surface connections without using an ablation process. For example, the disclosed systems and methods may customize segments of insulative and conductive materials at all layers (e.g., multiple layers) of the micro-coaxial cable. By connecting the conductive segments across multiple layers, the systems and methods described herein may enable the conductive core to connect to segments of the shell of the micro-coaxial cable.

By creating surface traces on the shell of the micro-coaxial cable, the disclosed systems and methods may also enable better connections to other electrical components. For example, the systems and methods described herein may connect conductive pads to the surface traces and connect electrical components to the conductive pads. Furthermore, the disclosed systems and methods may use elastic materials for the various layers, such as metal-loaded polymers or liquid metal for conductive layers, such that the micro-coaxial cable remains flexible to enable use in various wearable technology or other devices subject to repeated flexion. The systems and methods described herein may then route signals directly from a conductive core or set of cores to the surface of the shell, thereby significantly simplifying the interconnect process with other electronic components. Finally, the extrusion process may create the length of micro-coaxial cable in a single step using different conductive and insulative materials for the various layers of the cable.

In addition, the systems and methods described herein may improve the functioning of a computing device by improving the ease of connection between micro-coaxial cables and other electronic components, such as through increased surface connection junctions, and the structural integrity and flexibility of micro-coaxial cables, such as by using elastic materials. These systems and methods may also improve the fields of wearable technology and micro-coaxial cables by removing the need for ablation to customize connective sections of conductive cables, thereby enabling integration with flexible materials and improving the range of placement options for connective traces. Thus, the disclosed systems and methods may improve over traditional methods of customizing micro-coaxial cables and incorporating such cables into wearable technology.

Features from any of the embodiments described herein may be used in combination with one another in accordance with the general principles described herein. These and other embodiments, features, and advantages will be more fully understood upon reading the following detailed description in conjunction with the accompanying drawings and claims.

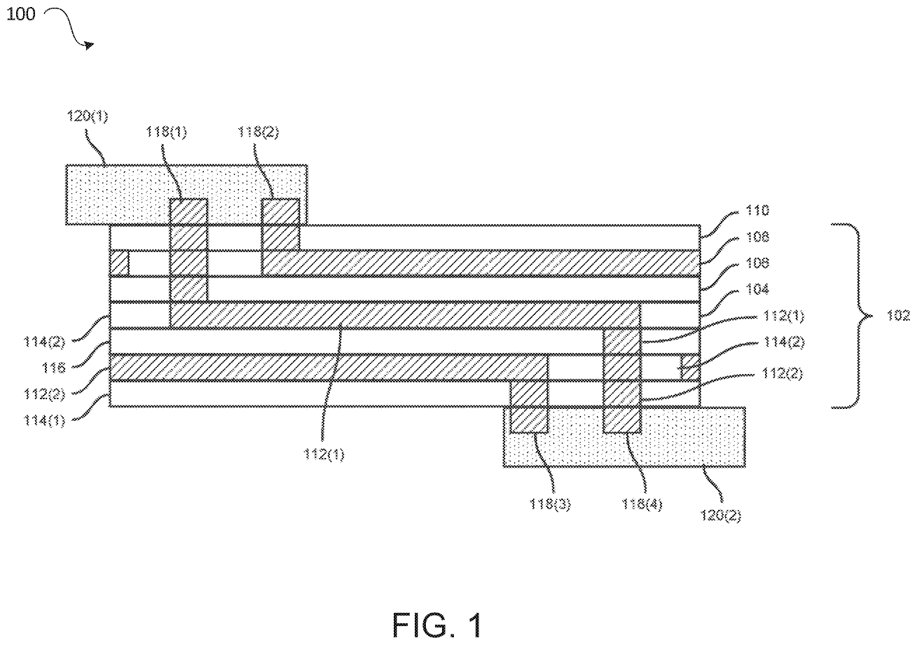

Turning now to the figures, FIG. 1 is a schematic diagram illustrating an example of a micro-coaxial cable, according to certain aspects of the disclosure. FIG. 1 illustrates a length-wise cross-section of a customized micro-coaxial cable with segments of insulative and conductive materials. As illustrated in FIG. 1, a micro-coaxial cable 102 may include a set of cores 104 that includes a conductive material 112(1) and segments of an insulative material 114(2) along a length of set of cores 104. In this example, micro-coaxial cable 102 may also include a dielectric layer 106, disposed around the length of set of cores 104, that includes a dielectric material 116 and one or more segments of conductive material 112(1). As illustrated in FIG. 1, dielectric layer 106 may be indicated above and below set of cores 104, due to the length-wise view of a tubular cable. In this example, micro-coaxial cable 102 may then include a shield layer 108, disposed around dielectric layer 106, that includes a conductive material 112(2) and segments of insulative material 114(2). Again, shield layer 108 may be disposed above and below dielectric layer 106 in the view of FIG. 1. In this example, micro-coaxial cable 102 may further include a shell 110, disposed around shield layer 108, that includes an insulative material 114(1) and segments of conductive material 112(2).

Although described as different materials with respect to FIG. 1, conductive materials 112(1)-(2) may represent the same conductive material. Similarly, insulative materials 114(1)-(2) may represent the same insulative material. Furthermore, dielectric material 116 may represent a material similar to insulative materials 114(1)-(2). In some examples, conductive material 112(1) of set of cores 104 may include a flowable conductive material that can be solidified or stay liquid in a final form. For example, a core may include a liquid metal that provides flexibility and electrical conduction as conductive material 112(1) and remains liquid at room temperature. In some examples, conductive material 112(2) of shield layer 108 may include a material that is solidifiable in the final form, such as a UV-curable resin with a conductive additive, to provide a solid connection at the surface.

Similarly, insulative materials 114(1)-(2) may include liquid or flowable materials that may be solidified in the final form. In these examples, insulative materials 114(1)-(2) and dielectric material 116 may include any appropriate non-conductive material such as UV curable polymers, polymer resins, acrylates, epoxies, silicone materials, and/or any other material that provides a predetermined minimum amount of flexibility and/or a low elastic modulus to resist deformation. For example, elastic materials may enable micro-coaxial cable 102 to stretch or bend without losing signal integrity while being durable and resistant to damage, thereby improving the reliability and lifespan of associated devices. In these examples, dielectric properties of dielectric material 116 may be tuned with dielectric additives. Alternatively, dielectric material 116 may include a material similar to insulative materials 114(1)-(2). Similarly, each layer of micro-coaxial cable 102 may be tunable based on various factors such as electrical conductivity, mechanical strength, flexibility, and thermal stability.

In some embodiments, micro-coaxial cable 102 may further include one or more conductive pads disposed on segments of conductive material 112(2) of shell 110, wherein a conductive pad is dimensioned to electronically couple an electrical component to one or more of a core in set of cores 104, dielectric layer 106, and/or shield layer 108. In the example of FIG. 1, conductive pads 118(1)-(4) couple electrical components 120(1)-(2) to conductive material 112(2) of shield layer 108 and conductive material 112(1) of set of cores 104. In other embodiments, electrical and electronic components may be coupled, via conductive pads, to other segments or layers of micro-coaxial cable 102. In additional embodiments, segments of insulative and/or conductive materials may be different from those illustrated in FIG. 1 to provide connections to conductive pads at different points along the length of micro-coaxial cable 102.

Furthermore, in alternate embodiments, micro-coaxial cable 102 may include additional or alternative layers than those illustrated in FIG. 1, such as additional layers of other conductive or insulative materials. In the above embodiments, micro-coaxial cable 102 may then be integrated into a larger electronic device or component, such as a smart textile. Examples of such devices may include, without limitation, laptops, tablets, desktops, servers, cellular phones, Personal Digital Assistants (PDAs), multimedia players, embedded systems, wearable devices (e.g., smart watches, smart glasses, etc.), gaming consoles, medical devices, devices used for artificial or virtual reality (AR/VR), combinations of one or more of the same, or any other suitable computing device.

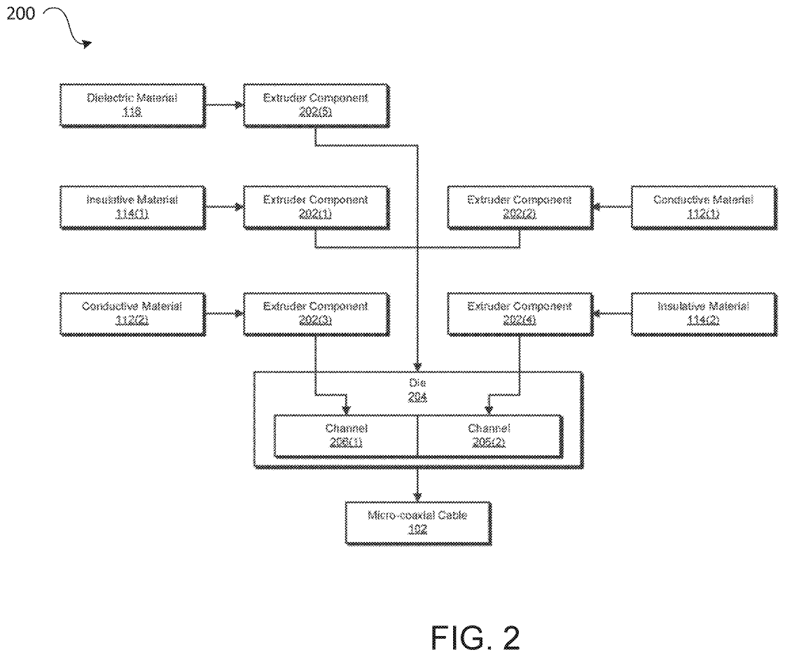

FIG. 2 is a block diagram illustrating an example of method of manufacturing a micro-coaxial cable, according to certain aspects of the disclosure.. In the example of FIG. 2, one or more of the systems described herein may separately load conductive materials and insulative materials to extruder components connected to a die designed to produce a shape of a micro-coaxial cable, wherein the die may include separate channels for conductive segments and insulative segments of the micro-coaxial cable. As used herein, the term “die” generally refers to a manufacturing tool that is customized to manipulate a material into a particular shape. The term “extruder,” as used herein, generally refers to a manufacturing tool that forces a material through a cross-section opening, such as an opening in a die. As illustrated in FIG. 2, conductive material 112(1) may be loaded to an extruder component 202(3), conductive material 112(2) may be loaded to an extruder component 202(2), insulative material 114(1) may be loaded to an extruder component 202(1), insulative material 114(2) may be loaded to an extruder component 202(4), and dielectric material 116 may be loaded to an extruder component 202(5). In some examples, each of insulative materials 114(1)-(2), conductive materials 112(1)-(2), and/or dielectric material 116 may be separately prepared from each other. In the example of FIG. 1, extruder components 202(1)-(4) may be connected to a die 204 designed to produce a shape of micro-coaxial cable 102 using the combination of conductive materials 112(1)-(2), insulative materials 114(1)-(2), and dielectric material 116.

In one embodiment, conductive material 112(1), conductive material 112(2), insulative material 114(1), insulative material 114(2), and dielectric material 116 may be immiscible during an extrusion manufacturing process. In other words, conductive materials 112(1)-(2), insulative materials 114(1)-(2), and dielectric material 116 should not easily mix when added together to form micro-coaxial cable 102. For example, low viscosity polymers and metal-filled polymers may be used in shield layer 108 to ensure materials are compatible with the extrusion manufacturing process. In other examples, additional materials and/or additional combinations of conductive and/or insulative materials may be added as needed to additional extruder components connected to die 204, depending on a design of micro-coaxial cable 102.

In some embodiments, the systems of FIG. 2 may extrude conductive materials 112(1), insulative materials 114(1), and dielectric material 116 through die 204 in a single step. In these embodiments, extruder components 202(1)-(5) may be connected to die 204 to produce a desired shape and size of micro-coaxial cable 102, such that the separate input materials form the desired shape and size as they exit die 204. In other embodiments, additional materials may be simultaneously extruded through die 204 to create the final shape and size of micro-coaxial cable 102.

In one embodiment, die 204 may include channels 206(1)-(2) to inject conductive material 112(2) and insulative material 114(2) to micro-coaxial cable 102. In some examples, the disclosed systems may customize the conductive segments and the insulative segments of various layers of micro-coaxial cable 102 by adjusting an injection of conductive materials and insulative materials through channels 206(1)-(2). In these examples, extruder components 202(3)-(4) may control the injection of materials at specific intervals to create specific lengths of segments in each layer of micro-coaxial cable 102. In other embodiments, additional extruder components and channels may be needed for additional customization of segments in layers of micro-coaxial cable 102. In these embodiments, the injection of conductive and insulative materials may occur as part of the extrusion manufacturing process.

In some embodiments, the segmentation of the additional materials may be determined by a predetermined design of micro-coaxial cable 102. For example, the disclosed systems may first use simulation to design the positioning and geometry of each segment of conductive or insulative material in each layer. In this example, the design may be determined by desired parameters for micro-coaxial cable 102 and/or by the behavior of the materials, such as fluid behavior and surface chemistry. In these embodiments, the design of micro-coaxial cable 102 may be pre-programmed to control extruder components 202(1)-(5) to produce the desired lengths of insulative or conductive segments. In some embodiments, the injection of the additional materials may be performed by syringes or other precision dispensing devices through channels 206(1)-(2). Furthermore, the materials of each segment may be immiscible to avoid mixing during injection.

In some examples, the system of FIG. 2 may include other components, such as a computing device and a pump controller component, that control the materials loaded into extruder components 202(1)-(5). For example, a computing device may determine the mixtures and amounts of conductive materials 112(1)-(2), insulative materials 114(1)-(2), and/or dielectric material 116. In some examples, the system of FIG. 2 may include one or more mixing blocks for mixing materials and one or more spinneret components that may be integrated with die 204 to feed the materials into die 204. For example, a more complex filament structure, such as a design with additional cores and/or additional layers, may require a larger number of spinnerets to act as separate channels of die 204.

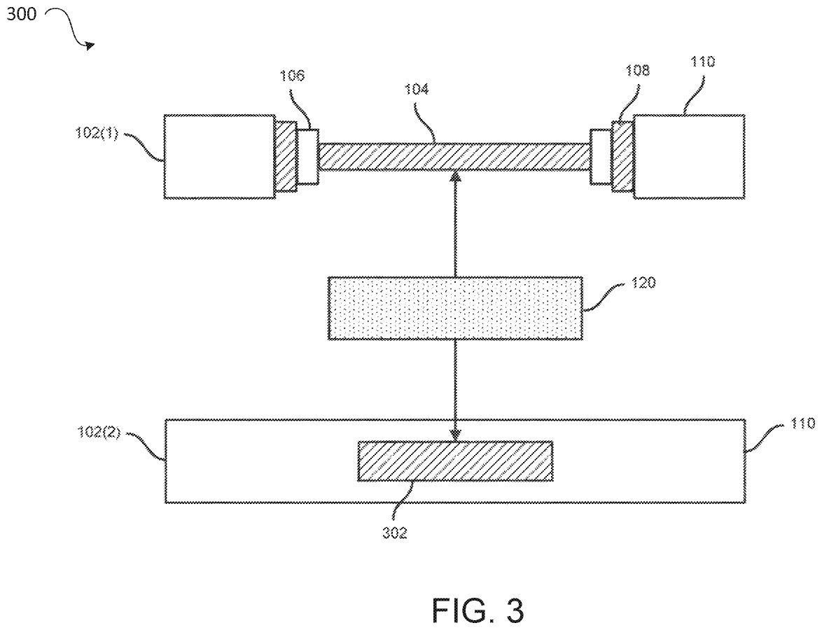

FIG. 3 is a schematic diagram illustrating top views of a comparison of exemplary micro-coaxial cable customized with ablation and without ablation, according to certain aspects of the disclosure. As shown in FIG. 3, a length of a micro-coaxial cable 102(1) may have exposed layers through an ablation process to wear away the other layers. In this example, an electrical component 120 may be paired with a core of micro-coaxial cable 102(1) after shell 110, shield layer 108, and dielectric layer 106 have been worn away through ablation to expose set of cores 104. In contrast, the disclosed systems and methods may customize a micro-coaxial cable 102(2) through an extrusion process to include surface connections for electrical component 120. In this example, conductive pads connecting electrical component 120 to hidden set of cores 104 may be disposed on a surface trace 302 of shell 110, wherein surface trace 302 may include one or more segments of conductive material 112(2). In this example, conductive pads may be soldered or crimped to surface trace 302.

In other examples, electrical component 120 may directly connect to surface traces 302 without additional connections. Additionally, different surface traces may connect to different layers of micro-coaxial cable 102(2), and electrical component 120 may be connected to the correct surface trace to electronically connect to the correct layer. In some examples, surface traces may be pre-printed into exact shapes and forms for connection to customized components, such as for unusual component placements or components tailored for specific users or uses.

As explained above in connection with FIGS. 1-3, the disclosed systems and methods may, by improving connection capabilities and customizability compared to traditional micro-coaxial cables, create flexible cables with arbitrary conductive or insulative segments as needed. Specifically, the disclosed systems and methods may customize the size and location of conductive and insulative regions along the shell of a micro-coaxial cable using surface traces to improve connections to other electrical components and create stronger and more reliable mechanical connections. The customizability may also improve shielding for electronic applications by reducing the need for ablation of larger areas of the cable and keeping sections of shielding intact. Thus, the systems and methods described herein may improve the customization of micro-coaxial cables without requiring ablation.

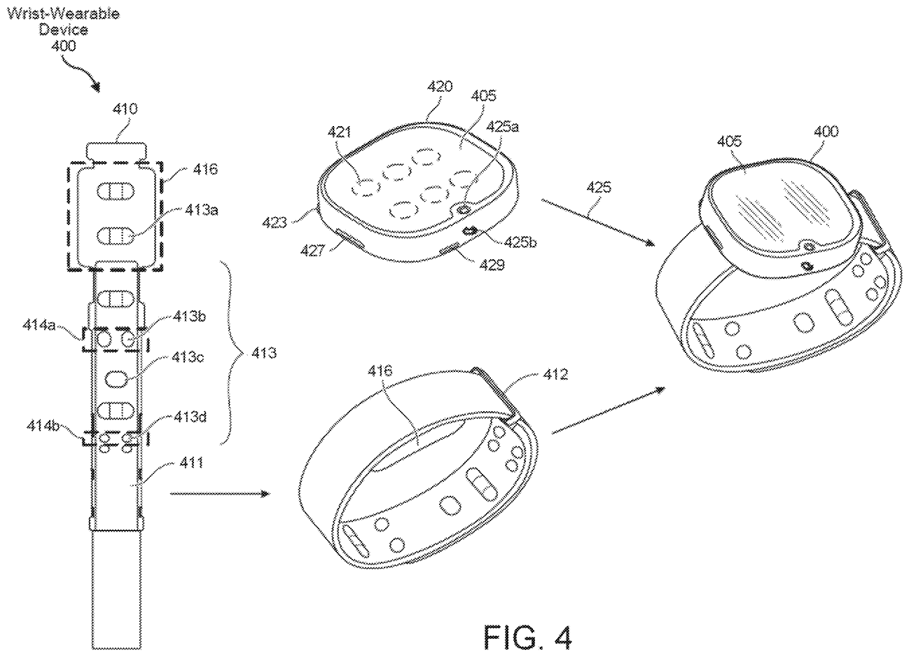

FIG. 4 is a schematic diagram illustrating an example of a wrist-wearable device using some aspects of the subject technology. FIG. 4 shows a wearable band 410 and a watch body 420 (or capsule) being coupled, as discussed below, to form wrist-wearable device 400. Wrist-wearable device 400 can perform various functions and/or operations associated with navigating through user interfaces and selectively opening applications.

As will be described in more detail below, operations executed by wrist-wearable device 400 can include (i) presenting content to a user (e.g., displaying visual content via a display 405), (ii) detecting (e.g., sensing) user input (e.g., sensing a touch on peripheral button 423 and/or at a touch screen of the display 405, a hand gesture detected by sensors (e.g., biopotential sensors)), and (iii) sensing biometric data (e.g., neuromuscular signals, heart rate, temperature, sleep, etc.) via one or more sensors 413, messaging (e.g., text, speech, video, etc.), image capture via one or more imaging devices or cameras 425, wireless communications (e.g., cellular, near field, Wi-Fi, personal area network, etc.), location determination, financial transactions, providing haptic feedback, providing alarms, providing notifications, providing biometric authentication, providing health monitoring, providing sleep monitoring, etc.

The above-example functions can be executed independently in watch body 420, independently in wearable band 410, and/or via an electronic communication between watch body 420 and wearable band 410. In some embodiments, functions can be executed on wrist-wearable device 400 while an AR environment is being presented. The wearable devices described herein can also be used with other types of AR environments.

Wearable band 410 can be configured to be worn by a user such that an inner surface of a wearable structure 411 of wearable band 410 is in contact with the user's skin. In this example, when worn by a user, sensors 413 may contact the user's skin. In some examples, one or more of sensors 413 can sense biometric data such as a user's heart rate, a saturated oxygen level, temperature, sweat level, neuromuscular signals, or a combination thereof. One or more of sensors 413 can also sense data about a user's environment including a user's motion, altitude, location, orientation, gait, acceleration, position, or a combination thereof. In some embodiments, one or more of sensors 413 can be configured to track a position and/or motion of wearable band 410. One or more of sensors 413 can include any of the sensors defined above and/or discussed below with respect to FIG. 4.

One or more of sensors 413 can be distributed on an inside and/or an outside surface of wearable band 410. In some embodiments, one or more of sensors 413 are uniformly spaced along wearable band 410. Alternatively, in some embodiments, one or more of sensors 413 are positioned at distinct points along wearable band 410. As shown in FIG. 4, one or more of sensors 413 can be the same or distinct. For example, in some embodiments, one or more of sensors 413 can be shaped as a pill (e.g., sensor 413a), an oval, a circle, a square, an oblong (e.g., sensor 413c) and/or any other shape that maintains contact with the user's skin (e.g., such that neuromuscular signals and/or other biometric data can be accurately measured at the user's skin). In some embodiments, one or more sensors of 413 are aligned to form pairs of sensors (e.g., for sensing neuromuscular signals based on differential sensing within each respective sensor). For example, sensor 413b may be aligned with an adjacent sensor to form sensor pair 414a and sensor 413d may be aligned with an adjacent sensor to form sensor pair 414b. In some embodiments, wearable band 410 does not have a sensor pair. Alternatively, in some embodiments, wearable band 410 has a predetermined number of sensor pairs (one pair of sensors, three pairs of sensors, four pairs of sensors, six pairs of sensors, sixteen pairs of sensors, etc.).

Wearable band 410 can include any suitable number of sensors 413. In some embodiments, the number and arrangement of sensors 413 depends on the particular application for which wearable band 410 is used. For instance, wearable band 410 can be configured as an armband, wristband, or chest-band that includes a plurality of sensors 413 with a different number of sensors 413, a variety of types of individual sensors with the plurality of sensors 413, and different arrangements for each use case, such as medical use cases as compared to gaming or general day-to-day use cases.

In accordance with some embodiments, wearable band 410 further includes an electrical ground electrode and a shielding electrode. The electrical ground and shielding electrodes, like the sensors 413, can be distributed on the inside surface of the wearable band 410 such that they contact a portion of the user's skin. For example, the electrical ground and shielding electrodes can be at an inside surface of a coupling mechanism 416 or an inside surface of a wearable structure 411. The electrical ground and shielding electrodes can be formed and/or use the same components as sensors 413. In some embodiments, wearable band 410 includes more than one electrical ground electrode and more than one shielding electrode.

Sensors 413 can be formed as part of wearable structure 411 of wearable band 410. In some embodiments, sensors 413 are flush or substantially flush with wearable structure 411 such that they do not extend beyond the surface of wearable structure 411. While flush with wearable structure 411, sensors 413 are still configured to contact the user's skin (e.g., via a skin-contacting surface). Alternatively, in some embodiments, sensors 413 extend beyond wearable structure 411 a predetermined distance (e.g., 0.1-2 mm) to make contact and depress into the user's skin. In some embodiments, sensors 413 are coupled to an actuator (not shown) configured to adjust an extension height (e.g., a distance from the surface of wearable structure 411) of sensors 413 such that sensors 413 make contact and depress into the user's skin. In some embodiments, the actuators adjust the extension height between 0.01 mm- 1.2 mm. This may allow the user to customize the positioning of sensors 413 to improve the overall comfort of the wearable band 410 when worn while still allowing sensors 413 to contact the user's skin. In some embodiments, sensors 413 are indistinguishable from wearable structure 411 when worn by the user.

Wearable structure 411 can be formed of an elastic material, elastomers, etc., configured to be stretched and fitted to be worn by the user. In some embodiments, wearable structure 411 is a textile or woven fabric. As described above, sensors 413 can be formed as part of a wearable structure 411. For example, sensors 413 can be molded into the wearable structure 411, or be integrated into a woven fabric (e.g., sensors 413 can be sewn into the fabric and mimic the pliability of fabric and/or can be constructed from a series of woven strands of fabric).

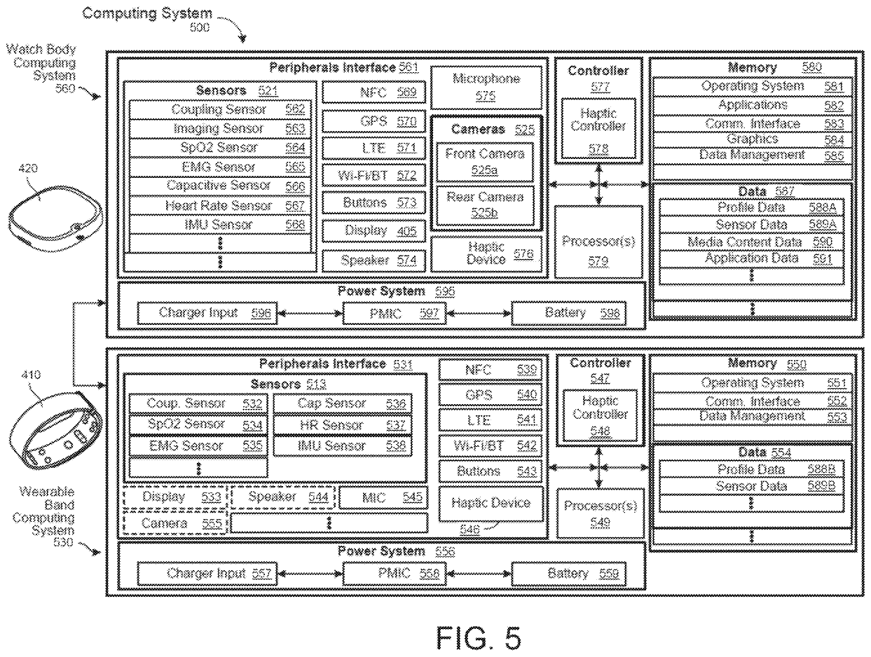

Wearable structure 411 can include flexible electronic connectors that interconnect sensors 413, the electronic circuitry, and/or other electronic components (described below in reference to FIG. 5) that are enclosed in wearable band 410. In some embodiments, the flexible electronic connectors are configured to interconnect sensors 413, the electronic circuitry, and/or other electronic components of wearable band 410 with respective sensors and/or other electronic components of another electronic device (e.g., watch body 420). The flexible electronic connectors are configured to move with wearable structure 411 such that the user adjustment to wearable structure 411 (e.g., resizing, pulling, folding, etc.) does not stress or strain the electrical coupling of components of wearable band 410.

As described above, wearable band 410 is configured to be worn by a user. In particular, wearable band 410 can be shaped or otherwise manipulated to be worn by a user. For example, wearable band 410 can be shaped to have a substantially circular shape such that it can be configured to be worn on the user's lower arm or wrist. Alternatively, wearable band 410 can be shaped to be worn on another body part of the user, such as the user's upper arm (e.g., around a bicep), forearm, chest, legs, etc. Wearable band 410 can include a retaining mechanism 412 (e.g., a buckle, a hook and loop fastener, etc.) for securing wearable band 410 to the user's wrist or other body part. While wearable band 410 is worn by the user, sensors 413 sense data (referred to as sensor data) from the user's skin. In some examples, sensors 413 of wearable band 410 obtain (e.g., sense and record) neuromuscular signals.

The sensed data (e.g., sensed neuromuscular signals) can be used to detect and/or determine the user's intention to perform certain motor actions. In some examples, sensors 413 may sense and record neuromuscular signals from the user as the user performs muscular activations (e.g., movements, gestures, etc.). The detected and/or determined motor actions (e.g., phalange (or digit) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on display 405 of wrist-wearable device 400 and/or can be transmitted to a device responsible for rendering an AR environment (e.g., a head-mounted display) to perform an action in an associated AR environment, such as to control the motion of a virtual device displayed to the user. The muscular activations performed by the user can include static gestures, such as placing the user's hand palm down on a table, dynamic gestures, such as grasping a physical or virtual object, and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by sensors 413 can be used to provide a user with an enhanced interaction with a physical object (e.g., devices communicatively coupled with wearable band 410) and/or a virtual object in an AR application generated by an AR system (e.g., user interface objects presented on the display 405, or another computing device (e.g., a smartphone)).

In some embodiments, wearable band 410 includes one or more haptic devices 946 (e.g., a vibratory haptic actuator) that are configured to provide haptic feedback (e.g., a cutaneous and/or kinesthetic sensation, etc.) to the user's skin. Sensors 413 and/or haptic devices 946 (shown in FIG. 9) can be configured to operate in conjunction with multiple applications including, without limitation, health monitoring, social media, games, and artificial reality (e.g., the applications associated with artificial reality).

Wearable band 410 can also include coupling mechanism 416 for detachably coupling a capsule (e.g., a computing unit) or watch body 420 (via a coupling surface of the watch body 420) to wearable band 410. For example, a cradle or a shape of coupling mechanism 416 can correspond to shape of watch body 420 of wrist-wearable device 400. In particular, coupling mechanism 416 can be configured to receive a coupling surface proximate to the bottom side of watch body 420 (e.g., a side opposite to a front side of watch body 420 where display 405 is located), such that a user can push watch body 420 downward into coupling mechanism 416 to attach watch body 420 to coupling mechanism 416. In some embodiments, coupling mechanism 416 can be configured to receive a top side of the watch body 420 (e.g., a side proximate to the front side of watch body 420 where display 405 is located) that is pushed upward into the cradle, as opposed to being pushed downward into coupling mechanism 416. In some embodiments, coupling mechanism 416 is an integrated component of wearable band 410 such that wearable band 410 and coupling mechanism 416 are a single unitary structure. In some embodiments, coupling mechanism 416 is a type of frame or shell that allows watch body 420's coupling surface to be retained within or on wearable band 410 coupling mechanism 416 (e.g., a cradle, a tracker band, a support base, a clasp, etc.).

Coupling mechanism 416 can allow for watch body 420 to be detachably coupled to the wearable band 410 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 420 to wearable band 410 and to decouple the watch body 420 from the wearable band 410. For example, a user can twist, slide, turn, push, pull, or rotate watch body 420 relative to wearable band 410, or a combination thereof, to attach watch body 420 to wearable band 410 and to detach watch body 420 from wearable band 410. Alternatively, as discussed below, in some embodiments, the watch body 420 can be decoupled from the wearable band 410 by actuation of a release mechanism 429.

Wearable band 410 can be coupled with watch body 420 to increase the functionality of wearable band 410 (e.g., converting wearable band 410 into wrist-wearable device 400, adding an additional computing unit and/or battery to increase computational resources and/or a battery life of wearable band 410, adding additional sensors to improve sensed data, etc.). As described above, wearable band 410 and coupling mechanism 416 are configured to operate independently (e.g., execute functions independently) from watch body 420. For example, coupling mechanism 416 can include one or more sensors 413 that contact a user's skin when wearable band 410 is worn by the user, with or without watch body 420 and can provide sensor data for determining control commands.

A user can detach watch body 420 from wearable band 410 to reduce the encumbrance of wrist-wearable device 400 to the user. For embodiments in which watch body 420 is removable, watch body 420 can be referred to as a removable structure, such that in these embodiments wrist-wearable device 400 includes a wearable portion (e.g., wearable band 410) and a removable structure (e.g., watch body 420).

Turning to watch body 420, in some examples, watch body 420 can have a substantially rectangular or circular shape. Watch body 420 is configured to be worn by the user on their wrist or on another body part. More specifically, watch body 420 is sized to be easily carried by the user, attached on a portion of the user's clothing, and/or coupled to wearable band 410 (forming the wrist-wearable device 400). As described above, watch body 420 can have a shape corresponding to coupling mechanism 416 of wearable band 410. In some embodiments, watch body 420 includes a single release mechanism 429 or multiple release mechanisms (e.g., two release mechanisms 429 positioned on opposing sides of watch body 420, such as spring-loaded buttons) for decoupling watch body 420 from wearable band 410. Release mechanism 429 can include, without limitation, a button, a knob, a plunger, a handle, a lever, a fastener, a clasp, a dial, a latch, or a combination thereof.

A user can actuate release mechanism 429 by pushing, turning, lifting, depressing, shifting, or performing other actions on release mechanism 429. Actuation of release mechanism 429 can release (e.g., decouple) watch body 420 from coupling mechanism 416 of wearable band 410, allowing the user to use watch body 420 independently from wearable band 410 and vice versa. For example, decoupling watch body 420 from wearable band 410 can allow a user to capture images using rear-facing camera 425b. Although release mechanism 429 is shown positioned at a corner of watch body 420, release mechanism 429 can be positioned anywhere on watch body 420 that is convenient for the user to actuate. In addition, in some embodiments, wearable band 410 can also include a respective release mechanism for decoupling watch body 420 from coupling mechanism 416. In some embodiments, release mechanism 429 is optional and watch body 420 can be decoupled from coupling mechanism 416 as described above (e.g., via twisting, rotating, etc.).

Watch body 420 can include one or more peripheral buttons 423 and 427 for performing various operations at watch body 420. For example, peripheral buttons 423 and 427 can be used to turn on or wake (e.g., transition from a sleep state to an active state) display 405, unlock watch body 420, increase or decrease a volume, increase or decrease a brightness, interact with one or more applications, interact with one or more user interfaces, etc. Additionally or alternatively, in some embodiments, display 405 operates as a touch screen and allows the user to provide one or more inputs for interacting with watch body 420.

In some embodiments, watch body 420 includes one or more sensors 421. Sensors 421 of watch body 420 can be the same or distinct from sensors 413 of wearable band 410. Sensors 421 of watch body 420 can be distributed on an inside and/or an outside surface of watch body 420. In some embodiments, sensors 421 are configured to contact a user's skin when watch body 420 is worn by the user. For example, sensors 421 can be placed on the bottom side of watch body 420 and coupling mechanism 416 can be a cradle with an opening that allows the bottom side of watch body 420 to directly contact the user's skin. Alternatively, in some embodiments, watch body 420 does not include sensors that are configured to contact the user's skin (e.g., including sensors internal and/or external to the watch body 420 that are configured to sense data of watch body 420 and the surrounding environment). In some embodiments, sensors 421 are configured to track a position and/or motion of watch body 420.

Watch body 420 and wearable band 410 can share data using a wired communication method (e.g., a Universal Asynchronous Receiver/Transmitter (UART), a USB transceiver, etc.) and/or a wireless communication method (e.g., near field communication, Bluetooth, etc.). For example, watch body 420 and wearable band 410 can share data sensed by sensors 413 and 421, as well as application and device specific information (e.g., active and/or available applications, output devices (e.g., displays, speakers, etc.), input devices (e.g., touch screens, microphones, imaging sensors, etc.)).

In some embodiments, watch body 420 can include, without limitation, a front-facing camera 425a and/or a rear-facing camera 425b, sensors 421 (e.g., a biometric sensor, an IMU, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 963), a touch sensor, a sweat sensor, etc.). In some embodiments, watch body 420 can include one or more haptic devices 976 (e.g., a vibratory haptic actuator) that is configured to provide haptic feedback (e.g., a cutaneous and/or kinesthetic sensation, etc.) to the user. Sensors 921 and/or haptic device 976 can also be configured to operate in conjunction with multiple applications including, without limitation, health monitoring applications, social media applications, game applications, and artificial reality applications (e.g., the applications associated with artificial reality).

As described above, watch body 420 and wearable band 410, when coupled, can form wrist-wearable device 400. When coupled, watch body 420 and wearable band 410 may operate as a single device to execute functions (operations, detections, communications, etc.) described herein. In some embodiments, each device may be provided with particular instructions for performing the one or more operations of wrist-wearable device 400. For example, in accordance with a determination that watch body 420 does not include neuromuscular signal sensors, wearable band 410 can include alternative instructions for performing associated instructions (e.g., providing sensed neuromuscular signal data to watch body 420 via a different electronic device). Operations of wrist-wearable device 400 can be performed by watch body 420 alone or in conjunction with wearable band 410 (e.g., via respective processors and/or hardware components) and vice versa. In some embodiments, operations of wrist-wearable device 400, watch body 420, and/or wearable band 410 can be performed in conjunction with one or more processors and/or hardware components.

As described below with reference to the block diagram of FIG. 9, wearable band 410 and/or watch body 420 can each include independent resources required to independently execute functions. For example, wearable band 410 and/or watch body 420 can each include a power source (e.g., a battery), a memory, data storage, a processor (e.g., a central processing unit (CPU)), communications, a light source, and/or input/output devices.

FIG. 5 is a diagram illustrating example block diagrams of a computing system corresponding to the wrist-wearable device of FIG. 4. The block diagram shown in FIG. 5 includes a block diagram of a computing system 530 corresponding to wearable band 410 and a computing system 560 corresponding to watch body 420, according to some embodiments. Computing system 500 of wrist-wearable device 400 may include a combination of components of wearable band computing system 530 and watch body computing system 560, in accordance with some embodiments.

Watch body 420 and/or wearable band 410 can include one or more components shown in watch body computing system 560. In some embodiments, a single integrated circuit may include all or a substantial portion of the components of watch body computing system 560 included in a single integrated circuit. Alternatively, in some embodiments, components of the watch body computing system 560 may be included in a plurality of integrated circuits that are communicatively coupled. In some embodiments, watch body computing system 560 may be configured to couple (e.g., via a wired or wireless connection) with wearable band computing system 530, which may allow the computing systems to share components, distribute tasks, and/or perform other operations described herein (individually or as a single device).

Watch body computing system 560 can include one or more processors 579, a controller 577, a peripherals interface 561, a power system 595, and memory (e.g., a memory 580). Power system 595 can include a charger input 596, a power-management integrated circuit (PMIC) 597, and a battery 598. In some embodiments, a watch body 420 and a wearable band 410 can have respective batteries (e.g., battery 598 and 559) and can share power with each other. Watch body 420 and wearable band 410 can receive a charge using a variety of techniques. In some embodiments, watch body 420 and wearable band 410 can use a wired charging assembly (e.g., power cords) to receive the charge. Alternatively, or in addition, watch body 420 and/or wearable band 410 can be configured for wireless charging. For example, a portable charging device can be designed to mate with a portion of watch body 420 and/or wearable band 410 and wirelessly deliver usable power to battery 598 of watch body 420 and/or battery 559 of wearable band 410. Watch body 420 and wearable band 410 can have independent power systems (e.g., power system 595 and 556, respectively) to enable each to operate independently. Watch body 420 and wearable band 410 can also share power (e.g., one can charge the other) via respective PMICs (e.g., PMICs 597 and 558) and charger inputs (e.g., 596 and 557) that can share power over power and ground conductors and/or over wireless charging antennas.

In some embodiments, peripherals interface 561 can include one or more sensors 521. Sensors 521 can include one or more coupling sensors 562 for detecting when watch body 420 is coupled with another electronic device (e.g., a wearable band 410). Sensors 521 can include one or more imaging sensors 563 (e.g., one or more of cameras 525, and/or separate imaging sensors 563 (e.g., thermal-imaging sensors)). In some embodiments, sensors 521 can include one or more SpO2 sensors 564. In some embodiments, sensors 521 can include one or more biopotential-signal sensors (e.g., EMG sensors 565, which may be disposed on an interior, user-facing portion of watch body 420 and/or wearable band 410). In some embodiments, sensors 521 may include one or more capacitive sensors 566. In some embodiments, sensors 521 may include one or more heart rate sensors 567. In some embodiments, sensors 521 may include one or more IMU sensors 568. In some embodiments, one or more IMU sensors 568 can be configured to detect movement of a user's hand or other location where watch body 420 is placed or held.

In some embodiments, one or more sensors 521 may provide an example human-machine interface. For example, a set of neuromuscular sensors, such as EMG sensors 565, may be arranged circumferentially around wearable band 410 with an interior surface of EMG sensors 565 being configured to contact a user's skin. Any suitable number of neuromuscular sensors may be used (e.g., between 2 and 20 sensors). The number and arrangement of neuromuscular sensors may depend on the particular application for which the wearable device is used. For example, wearable band 410 can be used to generate control information for controlling an augmented reality system, a robot, controlling a vehicle, scrolling through text, controlling a virtual avatar, or any other suitable control task.

In some embodiments, neuromuscular sensors may be coupled together using flexible electronics incorporated into the wireless device, and the output of one or more of the sensing components can be optionally processed using hardware signal processing circuitry (e.g., to perform amplification, filtering, and/or rectification). In other embodiments, at least some signal processing of the output of the sensing components can be performed in software such as processors 579. Thus, signal processing of signals sampled by the sensors can be performed in hardware, software, or by any suitable combination of hardware and software, as aspects of the technology described herein are not limited in this respect.

Neuromuscular signals may be processed in a variety of ways. For example, the output of EMG sensors 565 may be provided to an analog front end, which may be configured to perform analog processing (e.g., amplification, noise reduction, filtering, etc.) on the recorded signals. The processed analog signals may then be provided to an analog-to-digital converter, which may convert the analog signals to digital signals that can be processed by one or more computer processors. Furthermore, although this example is as discussed in the context of interfaces with EMG sensors, the embodiments described herein can also be implemented in wearable interfaces with other types of sensors including, but not limited to, mechanomyography (MMG) sensors, sonomyography (SMG) sensors, and electrical impedance tomography (EIT) sensors.

In some embodiments, peripherals interface 561 includes a near-field communication (NFC) component 569, a global-position system (GPS) component 570, a long-term evolution (LTE) component 571, and/or a Wi-Fi and/or Bluetooth communication component 572. In some embodiments, peripherals interface 561 includes one or more buttons 573 (e.g., peripheral buttons 423 and 427 in FIG. 4), which, when selected by a user, cause operation to be performed at watch body 420. In some embodiments, the peripherals interface 561 includes one or more indicators, such as a light emitting diode (LED), to provide a user with visual indicators (e.g., message received, low battery, active microphone and/or camera, etc.).

Watch body 420 can include at least one display 405 for displaying visual representations of information or data to a user, including user-interface elements and/or three-dimensional virtual objects. The display can also include a touch screen for inputting user inputs, such as touch gestures, swipe gestures, and the like. Watch body 420 can include at least one speaker 574 and at least one microphone 575 for providing audio signals to the user and receiving audio input from the user. The user can provide user inputs through microphone 575 and can also receive audio output from speaker 574 as part of a haptic event provided by haptic controller 578. Watch body 420 can include at least one camera 525, including a front camera 525a and a rear camera 525b. Cameras 525 can include ultra-wide-angle cameras, wide angle cameras, fish-eye cameras, spherical cameras, telephoto cameras, depth-sensing cameras, or other types of cameras.

Watch body computing system 560 can include one or more haptic controllers 578 and associated componentry (e.g., haptic devices 576) for providing haptic events at watch body 420 (e.g., a vibrating sensation or audio output in response to an event at the watch body 420). Haptic controllers 578 can communicate with one or more haptic devices 576, such as electroacoustic devices, including a speaker of the one or more speakers 574 and/or other audio components and/or electromechanical devices that convert energy into linear motion such as a motor, solenoid, electroactive polymer, piezoelectric actuator, electrostatic actuator, or other tactile output generating components (e.g., a component that converts electrical signals into tactile outputs on the device). Haptic controller 578 can provide haptic events that are capable of being sensed by a user of watch body 420. In some embodiments, one or more haptic controllers 578 can receive input signals from an application of applications 582.

In some embodiments, wearable band computing system 530 and/or watch body computing system 560 can include memory 580, which can be controlled by one or more memory controllers of controllers 577. In some embodiments, software components stored in memory 580 include one or more applications 582 configured to perform operations at the watch body 420. In some embodiments, one or more applications 582 may include games, word processors, messaging applications, calling applications, web browsers, social media applications, media streaming applications, financial applications, calendars, clocks, etc. In some embodiments, software components stored in memory 580 include one or more communication interface modules 583 as defined above. In some embodiments, software components stored in memory 580 include one or more graphics modules 584 for rendering, encoding, and/or decoding audio and/or visual data and one or more data management modules 585 for collecting, organizing, and/or providing access to data 587 stored in memory 580. In some embodiments, one or more of applications 582 and/or one or more modules can work in conjunction with one another to perform various tasks at the watch body 420.

In some embodiments, software components stored in memory 580 can include one or more operating systems 581 (e.g., a Linux-based operating system, an Android operating system, etc.). Memory 580 can also include data 587. Data 587 can include profile data 588A, sensor data 589A, media content data 590, and application data 591.

It should be appreciated that watch body computing system 560 is an example of a computing system within watch body 420, and that watch body 420 can have more or fewer components than shown in watch body computing system 560, can combine two or more components, and/or can have a different configuration and/or arrangement of the components. The various components shown in watch body computing system 560 are implemented in hardware, software, firmware, or a combination thereof, including one or more signal processing and/or application-specific integrated circuits.

Turning to the wearable band computing system 530, one or more components that can be included in wearable band 410 are shown. Wearable band computing system 530 can include more or fewer components than shown in watch body computing system 560, can combine two or more components, and/or can have a different configuration and/or arrangement of some or all of the components. In some embodiments, all, or a substantial portion of the components of wearable band computing system 530 are included in a single integrated circuit. Alternatively, in some embodiments, components of wearable band computing system 530 are included in a plurality of integrated circuits that are communicatively coupled. As described above, in some embodiments, wearable band computing system 530 is configured to couple (e.g., via a wired or wireless connection) with watch body computing system 560, which allows the computing systems to share components, distribute tasks, and/or perform other operations described herein (individually or as a single device).

Wearable band computing system 530, similar to watch body computing system 560, can include one or more processors 549, one or more controllers 547 (including one or more haptics controllers 548), a peripherals interface 531 that can includes one or more sensors 513 and other peripheral devices, a power source (e.g., a power system 556), and memory (e.g., a memory 550) that includes an operating system (e.g., an operating system 551), data (e.g., data 554 including profile data 588B, sensor data 589B, etc.), and one or more modules (e.g., a communications interface module 552, a data management module 553, etc.).

One or more sensors 513 can be analogous to sensors 521 of watch body computing system 560. For example, sensors 513 can include one or more coupling sensors 532, one or more SpO2 sensors 534, one or more EMG sensors 535, one or more capacitive sensors 536, one or more heart rate sensors 537, and one or more IMU sensors 538.

Peripherals interface 531 can also include other components analogous to those included in peripherals interface 561 of watch body computing system 560, including an NFC component 539, a GPS component 540, an LTE component 541, a Wi-Fi and/or Bluetooth communication component 542, and/or one or more haptic devices 546 as described above in reference to peripherals interface 561. In some embodiments, peripherals interface 531 includes one or more buttons 543, a display 533, a speaker 544, a microphone 545, and a camera 555. In some embodiments, peripherals interface 531 includes one or more indicators, such as an LED.

It should be appreciated that wearable band computing system 530 is an example of a computing system within wearable band 410, and that wearable band 410 can have more or fewer components than shown in wearable band computing system 530, combine two or more components, and/or have a different configuration and/or arrangement of the components. The various components shown in wearable band computing system 530 can be implemented in one or more of a combination of hardware, software, or firmware, including one or more signal processing and/or application-specific integrated circuits.

Wrist-wearable device 400 with respect to FIG. 4 is an example of wearable band 410 and watch body 420 coupled together, so wrist-wearable device 400 will be understood to include the components shown and described for wearable band computing system 530 and watch body computing system 560. In some embodiments, wrist-wearable device 400 has a split architecture (e.g., a split mechanical architecture, a split electrical architecture, etc.) between watch body 420 and wearable band 410. In other words, all of the components shown in wearable band computing system 530 and watch body computing system 560 can be housed or otherwise disposed in a combined wrist-wearable device 400 or within individual components of watch body 420, wearable band 410, and/or portions thereof (e.g., a coupling mechanism 416 of wearable band 410).

The techniques described above can be used with any device for sensing neuromuscular signals but could also be used with other types of wearable devices for sensing neuromuscular signals (such as body-wearable or head-wearable devices that might have neuromuscular sensors closer to the brain or spinal column).

In some embodiments, wrist-wearable device 400 can be used in conjunction with a head-wearable device (e.g., AR system 600 and VR system 710) and/or an HIPD, and wrist-wearable device 400 can also be configured to be used to allow a user to control any aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable devices, attention will now be turned to example head-wearable devices, such AR system 600 and VR system 710.

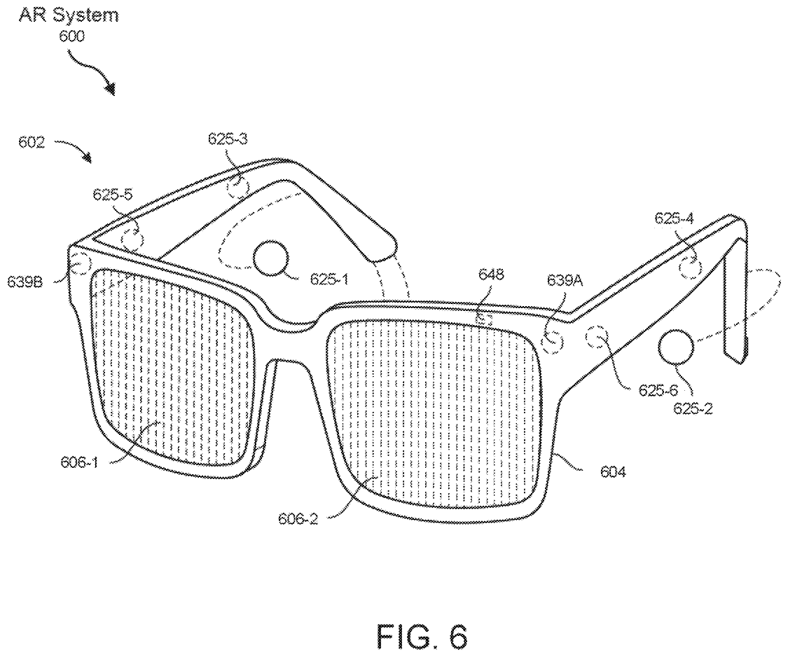

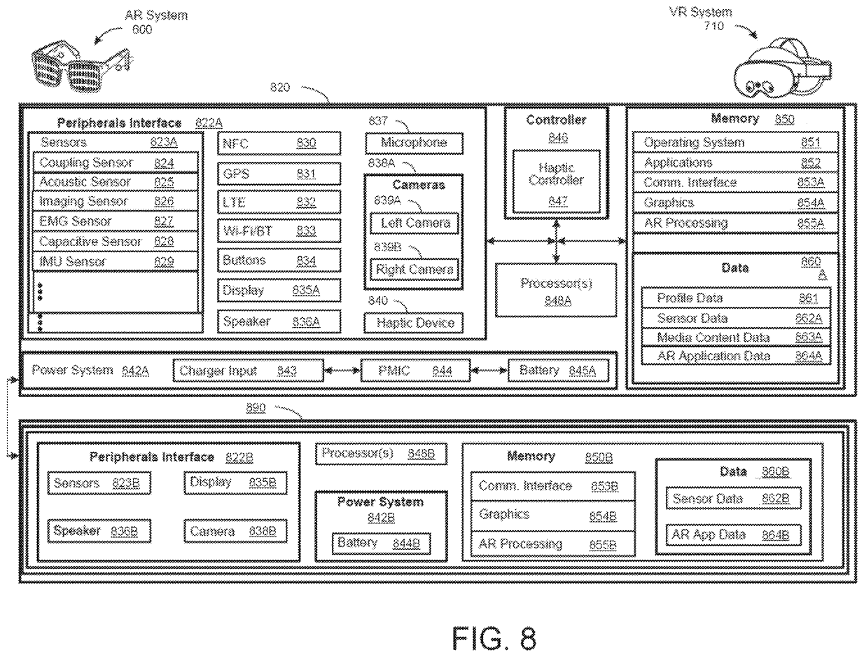

FIG. 6 is a schematic diagram illustrating an example of an augmented reality (AR) system using some aspects of the subject technology. FIG. 6 shows an example visual depiction of the AR system 600, including an eyewear device 602 (which may also be described herein as augmented-reality glasses, and/or smart glasses). AR system 600 can include additional electronic components that are not shown in FIG. 6, such as a wearable accessory device and/or an intermediary processing device, in electronic communication or otherwise configured to be used in conjunction with the eyewear device 602. In some embodiments, the wearable accessory device and/or the intermediary processing device may be configured to couple with eyewear device 602 via a coupling mechanism in electronic communication with a coupling sensor 824 (FIG. 8), where coupling sensor 824 can detect when an electronic device becomes physically or electronically coupled with eyewear device 602. In some embodiments, eyewear device 602 can be configured to couple to a housing 890 (FIG. 8), which may include one or more additional coupling mechanisms configured to couple with additional accessory devices. The components shown in FIG. 6 can be implemented in hardware, software, firmware, or a combination thereof, including one or more signal-processing components and/or application-specific integrated circuits (ASICs).

Eyewear device 602 includes mechanical glasses components, including a frame 604 configured to hold one or more lenses (e.g., one or both lenses 606-1 and 606-2). One of ordinary skill in the art will appreciate that eyewear device 602 can include additional mechanical components, such as hinges configured to allow portions of frame 604 of eyewear device 602 to be folded and unfolded, a bridge configured to span the gap between lenses 606-1 and 606-2 and rest on the user's nose, nose pads configured to rest on the bridge of the nose and provide support for eyewear device 602, earpieces configured to rest on the user's ears and provide additional support for eyewear device 602, temple arms configured to extend from the hinges to the earpieces of eyewear device 602, and the like. One of ordinary skill in the art will further appreciate that some examples of AR system 600 can include none of the mechanical components described herein. For example, smart contact lenses configured to present artificial reality to users may not include any components of eyewear device 602.

Eyewear device 602 includes electronic components, many of which will be described in more detail below with respect to FIG. 8. Some example electronic components are illustrated in FIG. 6, including acoustic sensors 625-1, 625-2, 625-3, 625-4, 625-5, and 625-6, which can be distributed along a substantial portion of the frame 604 of eyewear device 602. Eyewear device 602 also includes a left camera 639A and a right camera 639B, which are located on different sides of the frame 604. Eyewear device 602 also includes a processor 648 (or any other suitable type or form of integrated circuit) that is embedded into a portion of the frame 604.

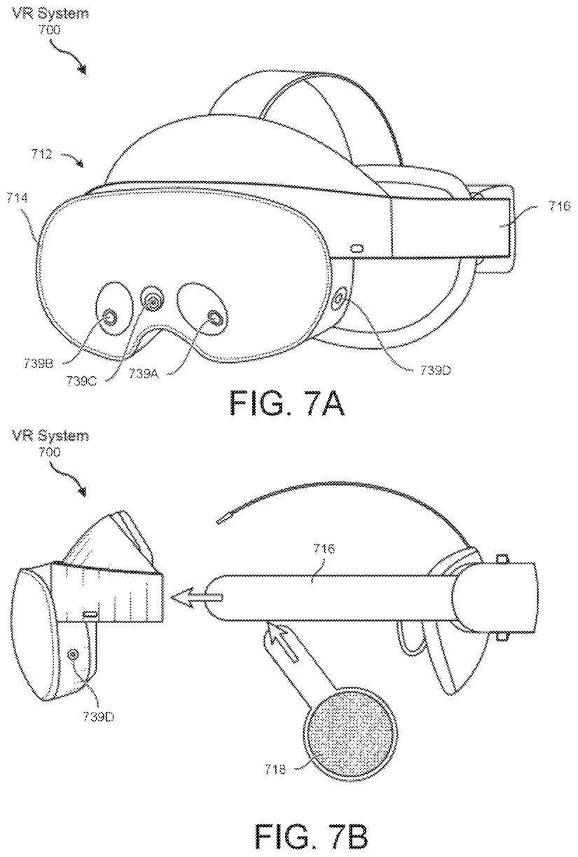

FIGS. 7A and 7B are schematic diagrams illustrating an example of a virtual reality (VR) system using some aspects of the subject technology. VR system 710 includes a head-mounted display (HMD) 712 (e.g., also referred to herein as an AR headset, a head-wearable device, a VR headset, etc.), in accordance with some embodiments. As noted, some AR systems (e.g., AR system 600) may, instead of blending an artificial reality with actual reality, substantially replace one or more of a user's visual and/or other sensory perceptions of the real world with a virtual experience (e.g., AR systems 600 and 700).

HMD 712 includes a front body 714 and a frame 716 (e.g., a strap or band) shaped to fit around a user's head. In some embodiments, front body 714 and/or frame 716 include one or more electronic elements for facilitating presentation of and/or interactions with an AR and/or VR system (e.g., displays, IMUs, tracking emitters or detectors). In some embodiments, HMD 712 includes output audio transducers (e.g., an audio transducer 718), as shown in FIG. 7B. In some embodiments, one or more components, such as the output audio transducer(s) 718 and frame 716, can be configured to attach and detach (e.g., are detachably attachable) to HMD 712 (e.g., a portion or all of frame 716, and/or audio transducer 718), as shown in FIG. 7B. In some embodiments, coupling a detachable component to HMD 712 causes the detachable component to come into electronic communication with HMD 712.

FIGS. 7A and 7B also show that VR system 710 includes one or more cameras, such as left camera 739A and right camera 739B, which can be analogous to left and right cameras 639A and 639B on frame 604 of eyewear device 602. In some embodiments, VR system 710 includes one or more additional cameras (e.g., cameras 739C and 739D), which can be configured to augment image data obtained by left and right cameras 739A and 739B by providing more information. For example, camera 739C can be used to supply color information that is not discerned by cameras 739A and 739B. In some embodiments, one or more of cameras 739A to 739D can include an optional IR cut filter configured to remove IR light from being received at the respective camera sensors.

FIG. 8 is a diagram illustrating example block diagrams of a computing system corresponding to the AR device of FIG. 6 and the VR device of FIG. 7. The system components include a computing system 820 and an optional housing 890, each of which show components that can be included in AR system 600 and/or VR system 710. In some embodiments, more or fewer components can be included in optional housing 890 depending on practical restraints of the respective AR system being described.

In some embodiments, computing system 820 can include one or more peripherals interfaces 822A and/or optional housing 890 can include one or more peripherals interfaces 822B. Each computing system 820 and optional housing 890 can also include one or more power systems 842A and 842B, one or more controllers 846 (including one or more haptic controllers 847), one or more processors 848A and 848B (as defined above, including any of the examples provided), and memory 850A and 850B, which can all be in electronic communication with each other. For example, the one or more processors 848A and 848B can be configured to execute instructions stored in memory 850A and 850B, which can cause a controller of one or more of controllers 846 to cause operations to be performed at one or more peripheral devices connected to peripherals interface 822A and/or 822B. In some embodiments, each operation described can be powered by electrical power provided by power system 842A and/or 842B.

In some embodiments, peripherals interface 822A can include one or more devices configured to be part of computing system 820, some of which have been defined above and/or described with respect to the wrist-wearable devices shown in FIGS. 8 and 5. For example, peripherals interface 822A can include one or more sensors 823A. Some example sensors 823A include one or more coupling sensors 824, one or more acoustic sensors 825, one or more imaging sensors 826, one or more EMG sensors 827, one or more capacitive sensors 828, one or more IMU sensors 829, and/or any other types of sensors explained above or described with respect to any other embodiments discussed herein.

In some embodiments, peripherals interfaces 822A and 822B can include one or more additional peripheral devices, including one or more NFC devices 830, one or more GPS devices 831, one or more LTE devices 832, one or more Wi-Fi and/or Bluetooth devices 833, one or more buttons 834 (e.g., including buttons that are slidable or otherwise adjustable), one or more displays 835A and 835B, one or more speakers 836A and 836B, one or more microphones 837, one or more cameras 838A and 838B (e.g., including the left camera 839A and/or a right camera 839B), one or more haptic devices 840, and/or any other types of peripheral devices defined above or described with respect to any other embodiments discussed herein.

AR systems can include a variety of types of visual feedback mechanisms (e.g., presentation devices). For example, display devices in AR system 600 and/or VR system 710 can include one or more liquid-crystal displays (LCDs), light emitting diode (LED) displays, organic LED (OLED) displays, and/or any other suitable types of display screens. AR systems can include a single display screen (e.g., configured to be seen by both eyes), and/or can provide separate display screens for each eye, which can allow for additional flexibility for varifocal adjustments and/or for correcting a refractive error associated with a user's vision. Some embodiments of AR systems also include optical subsystems having one or more lenses (e.g., conventional concave or convex lenses, Fresnel lenses, or adjustable liquid lenses) through which a user can view a display screen.

For example, respective displays 835A and 835B can be coupled to each of the lenses 606-1 and 606-2 of AR system 600. Displays 835A and 835B may be coupled to each of lenses 606-1 and 606-2, which can act together or independently to present an image or series of images to a user. In some embodiments, AR system 600 includes a single display 835A or 835B (e.g., a near-eye display) or more than two displays 835A and 835B. In some embodiments, a first set of one or more displays 835A and 835B can be used to present an augmented-reality environment, and a second set of one or more display devices 835A and 835B can be used to present a VR environment. In some embodiments, one or more waveguides are used in conjunction with presenting AR content to the user of AR system 600 (e.g., as a means of delivering light from one or more displays 835A and 835B to the user's eyes). In some embodiments, one or more waveguides are fully or partially integrated into the eyewear device 602. Additionally, or alternatively to display screens, some AR systems include one or more projection systems. For example, display devices in AR system 600 and/or VR system 710 can include micro-LED projectors that project light (e.g., using a waveguide) into display devices, such as clear combiner lenses that allow ambient light to pass through. The display devices can refract the projected light toward a user's pupil and can enable a user to simultaneously view both AR content and the real world. AR systems can also be configured with any other suitable type or form of image projection system. In some embodiments, one or more waveguides are provided additionally or alternatively to the one or more display(s) 835A and 835B.

Computing system 820 and/or optional housing 890 of AR system 600 or VR system 710 can include some or all of the components of a power system 842A and 842B. Power systems 842A and 842B can include one or more charger inputs 843, one or more PMICs 844, and/or one or more batteries 845A and 844B.

Memory 850A and 850B may include instructions and data, some or all of which may be stored as non-transitory computer-readable storage media within the memories 850A and 850B. For example, memory 850A and 850B can include one or more operating systems 851, one or more applications 852, one or more communication interface applications 853A and 853B, one or more graphics applications 854A and 854B, one or more AR processing applications 855A and 855B, and/or any other types of data defined above or described with respect to any other embodiments discussed herein.

Memory 850A and 850B also include data 860A and 860B, which can be used in conjunction with one or more of the applications discussed above. Data 860A and 860B can include profile data 861, sensor data 862A and 862B, media content data 863A, AR application data 864A and 864B, and/or any other types of data defined above or described with respect to any other embodiments discussed herein.

In some embodiments, controller 846 of eyewear device 602 may process information generated by sensors 823A and/or 823B on eyewear device 602 and/or another electronic device within AR system 600. For example, controller 846 can process information from acoustic sensors 625-1 and 625-2. For each detected sound, controller 846 can perform a direction of arrival (DOA) estimation to estimate a direction from which the detected sound arrived at eyewear device 602 of AR system 600. As one or more of acoustic sensors 825 (e.g., the acoustic sensors 625-1, 625-2) detects sounds, controller 846 can populate an audio data set with the information (e.g., represented in FIG. 8 as sensor data 862A and 862B).

In some embodiments, a physical electronic connector can convey information between eyewear device 602 and another electronic device and/or between one or more processors 648, 848A, 848B of AR system 600 or VR system 710 and controller 846. The information can be in the form of optical data, electrical data, wireless data, or any other transmittable data form. Moving the processing of information generated by eyewear device 602 to an intermediary processing device can reduce weight and heat in the eyewear device, making it more comfortable and safer for a user. In some embodiments, an optional wearable accessory device (e.g., an electronic neckband) is coupled to eyewear device 602 via one or more connectors. The connectors can be wired or wireless connectors and can include electrical and/or non-electrical (e.g., structural) components. In some embodiments, eyewear device 602 and the wearable accessory device can operate independently without any wired or wireless connection between them.

AR systems can include various types of computer vision components and subsystems. For example, AR system 600 and/or VR system 710 can include one or more optical sensors such as two-dimensional (2D) or three-dimensional (3D) cameras, time-of-flight depth sensors, structured light transmitters and detectors, single-beam or sweeping laser rangefinders, 3D LiDAR sensors, and/or any other suitable type or form of optical sensor. An AR system can process data from one or more of these sensors to identify a location of a user and/or aspects of the user's real-world physical surroundings, including the locations of real-world objects within the real-world physical surroundings. In some embodiments, the methods described herein are used to map the real world, to provide a user with context about real-world surroundings, and/or to generate digital twins (e.g., interactable virtual objects), among a variety of other functions. For example, FIGS. 7A and 7B show VR system 710 having cameras 739A to 739D, which can be used to provide depth information for creating a voxel field and a two-dimensional mesh to provide object information to the user to avoid collisions.

In some embodiments, AR system 600 and/or VR system 710 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other AR devices, within other AR devices, and/or in conjunction with other AR devices.

In some embodiments of an artificial reality system, such as AR system 600 and/or VR system 710, ambient light (e.g., a live feed of the surrounding environment that a user would normally see) can be passed through a display element of a respective head-wearable device presenting aspects of the AR system. In some embodiments, ambient light can be passed through a portion that is less than all of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable device, and an amount of ambient light (e.g., 15-50% of the ambient light) can be passed through the user interface element such that the user can distinguish at least a portion of the physical environment over which the user interface element is being displayed.

An aspect of the subject technology is directed to a method that includes fabricating a customized micro-coaxial cable by using an extrusion process to connect a conductive core to a surface of a micro-coaxial cable and providing surface connections without using an ablation process.

In some implementations, connecting the conductive core to the surface of the micro-coaxial cable comprises connecting the conductive core to the surface of the micro-coaxial cable at customizable intervals.

In one or more implementations, the method further comprises customizing segments of insulative and conductive materials at a plurality of layers of the micro-coaxial cable.

In some implementations, the customizing segments of the insulative and conductive materials comprise connecting conductive segments across the plurality of layers.

In one or more implementations, the method further comprises using elastic materials for conductive layers of the plurality of layers, wherein the elastic materials include metal-loaded polymers or liquid metals.

In some implementations, the method further comprises creating surface traces on a shell of the micro-coaxial cable.

In one or more implementations, the method further comprises connecting conductive pads to the surface traces and connecting electrical components to the conductive pads.

In some implementations, the method further comprises routing signals directly from one or more conductive cores to the surface traces of the shell to simplify an interconnect process with one or more electronic components.

In one or more implementations, using the extrusion process comprises creating a length of the micro-coaxial cable in a single step using different conductive and insulative materials for various layers of the micro-coaxial cable.

Another aspect of the subject technology is directed to a device that includes a customized micro-coaxial cable that comprise a conductive core connected to a surface of a micro-coaxial cable at customizable intervals, and customized segments of insulative and conductive materials at a plurality of layers of the micro-coaxial cable. The customized micro-coaxial cable is fabricated using an extrusion process.

In some implementations, the customizing segments of the insulative and conductive materials include conductive segments connected across the plurality of layers.

In one or more implementations, the plurality of layers comprise conductive layers formed of elastic materials, and wherein the elastic materials include metal-loaded polymers or liquid metals.

In some implementations, the device further comprises surface traces created on a shell of the micro-coaxial cable and connected to one or more conductive cores of the micro-coaxial cable.

In one or more implementations, the device further comprises conductive pads electrically connected to the surface traces.

In some implementations, the conductive pads are configured to interconnect electrical components to the one or more conductive cores of the micro-coaxial cable.

In one or more implementations, the surface traces are configured to route signals from the one or more conductive cores to the surface traces of the shell of the micro-coaxial cable to simplify an interconnect process with one or more electronic components.

In some implementations, the extrusion process is configured to create a length of the micro-coaxial cable in a single step using different conductive and insulative materials for various layers of the micro-coaxial cable.

Yet another aspect of the subject technology is directed to a wearable device that includes electronic circuitry and flexible electronic connectors including a customized micro-coaxial cable. The customized micro-coaxial cable includes a conductive core connected to a surface of a micro-coaxial cable at customizable intervals, and customized segments of insulative and conductive materials at a plurality of layers of the micro-coaxial cable. The customized micro-coaxial cable is fabricated using an extrusion process.

In one or more implementations, the plurality of layers comprise conductive layers formed of elastic materials, and the elastic materials include metal-loaded polymers or liquid metals.

In some implementations, the device further comprises surface traces created on a shell of the micro-coaxial cable and connected to one or more conductive cores of the micro-coaxial cable; and conductive pads electrically connected to the surface traces, and the conductive pads are electrically connected to the surface traces and are configured to interconnect the electronic circuitry to the one or more conductive cores of the micro-coaxial.

In some implementations, the word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially described as such, one or more features from a described combination can in some cases be excised from the combination, and the described combination may be directed to a sub-combination or variation of a sub-combination.

The subject matter of this specification has been described in terms of particular aspects, but other aspects can be implemented and are within the scope of the following clauses. For example, while operations are depicted in the drawings in a particular order, this should not be understood as requiring that such operations be performed in the particular order shown or in sequential order, or that all illustrated operations be performed, to achieve desirable results. The actions recited in the clauses can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the clauses. In addition, in the detailed description, it can be seen that the description provides illustrative examples, and the various features are grouped together in various implementations for the purpose of streamlining the disclosure. The method of disclosure is not to be interpreted as reflecting an intention that the described subject matter requires more features than are expressly recited in each clause. Rather, as the clauses reflect, inventive subject matter lies in less than all features of a single disclosed configuration or operation. The clauses are hereby incorporated into the detailed description, with each clause standing on its own as a separately described subject matter.

As used herein, the phrase “at least one of” preceding a series of items, with the terms “and” or “or” to separate any of the items, modifies the list as a whole, rather than each member of the list (i.e., each item).

To the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A method comprising:
fabricating a customized micro-coaxial cable by:
using an extrusion process to connect a conductive core to a surface of a micro-coaxial cable; and
providing surface connections without using an ablation process.

2. The method of claim 1, wherein connecting the conductive core to the surface of the micro-coaxial cable comprises connecting the conductive core to the surface of the micro-coaxial cable at customizable intervals.

3. The method of claim 1, further comprising customizing segments of insulative and conductive materials at a plurality of layers of the micro-coaxial cable.

4. The method of claim 3, wherein the customizing segments of the insulative and conductive materials comprise connecting conductive segments across the plurality of layers.

5. The method of claim 4, further comprising using elastic materials for conductive layers of the plurality of layers, wherein the elastic materials include metal-loaded polymers or liquid metals.

6. The method of claim 1, further comprising creating surface traces on a shell of the micro-coaxial cable.

7. The method of claim 6, further comprising connecting conductive pads to the surface traces and connecting electrical components to the conductive pads.

8. The method of claim 6, further comprising routing signals directly from one or more conductive cores to the surface traces of the shell to simplify an interconnect process with one or more electronic components.

9. The method of claim 1, wherein using the extrusion process comprises creating a length of the micro-coaxial cable in a single step using different conductive and insulative materials for various layers of the micro-coaxial cable.

10. A device comprising:
a customized micro-coaxial cable comprising:
a conductive core connected to a surface of a micro-coaxial cable at customizable intervals; and
customized segments of insulative and conductive materials at a plurality of layers of the micro-coaxial cable,
wherein the customized micro-coaxial cable is fabricated using an extrusion process.

11. The device of claim 10, wherein the customizing segments of the insulative and conductive materials include conductive segments connected across the plurality of layers.

12. The device of claim 10, wherein the plurality of layers comprise conductive layers formed of elastic materials, and wherein the elastic materials include metal-loaded polymers or liquid metals.

13. The device of claim 10, further comprising surface traces created on a shell of the micro-coaxial cable and connected to one or more conductive cores of the micro-coaxial cable.

14. The device of claim 13, further comprising conductive pads electrically connected to the surface traces.

15. The device of claim 14, wherein and the conductive pads are configured to interconnect electrical components to the one or more conductive cores of the micro-coaxial cable.

16. The device of claim 14, wherein the surface traces are configured to route signals from the one or more conductive cores to the surface traces of the shell of the micro-coaxial cable to simplify an interconnect process with one or more electronic components.

17. The device of claim 10, wherein the extrusion process is configured to create a length of the micro-coaxial cable in a single step using different conductive and insulative materials for various layers of the micro-coaxial cable.

18. A wearable device comprising:
electronic circuitry; and
flexible electronic connectors including a customized micro-coaxial cable comprising:
a conductive core connected to a surface of a micro-coaxial cable at customizable intervals; and
customized segments of insulative and conductive materials at a plurality of layers of the micro-coaxial cable,
wherein the customized micro-coaxial cable is fabricated using an extrusion process.

19. The wearable device of claim 18, wherein:
the plurality of layers comprise conductive layers formed of elastic materials, and
the elastic materials include metal-loaded polymers or liquid metals.

20. The wearable device of claim 18, further comprising:
surface traces created on a shell of the micro-coaxial cable and connected to one or more conductive cores of the micro-coaxial cable; and
conductive pads electrically connected to the surface traces, wherein:
the conductive pads are electrically connected to the surface traces and are configured to interconnect the electronic circuitry to the one or more conductive cores of the micro-coaxial cable.
